(19) United States
(12) Patent Application Publication
(10) Pub. No.: US 2011/0101252 A1
(43) Pub. Date: May 5, 2011

(54) Method of protection of human (livestock) from bites of blood-sucking insects.

(75) Inventor: Vladimir Nikolaevich Rubochkin, Ulyanovsk (RU)

(73) Assignee: Vladimir Nikolaevich Rubochkin, Ulyanovsk (RU)

(21) Appl. No.: 13/004,943

(22) Filed: Jan. 12, 2011

(30) Foreign Application Priority Data
Oct. 2, 2009 (RU) 2009136604

(51) Int. Cl. G01J 3/10

(52) U.S. Cl. 250/504 R

(57) ABSTRACT

The method of protection of human (livestock) from bites of blood-sucking insects which based on fact, that mosquitoes and other blood-sucking insects have principally infrared vision and actively attack people or animals at night, in twilight or in the shade, that is, in the conditions optimum for detecting infra-red emission of a body of the person and animals. The method consists in creating in protected zones of the thermal hindrances, which deprive blood-sucking insects of ability to define position of people (of animals). The method consists in placing in protected zone of (one or several) sources of the infra-red emission; diagrams of emission and a places of placing of infra-red sources must be organized so that this emission would to hit in eyes of insects (thermal sensors of insects) in the majority of possible points of supervision by them of people (of animals); power of emission must to exceed power output of infra-red emission of vulnerable parts of a body of the person (of animals); infra-red sources can operate constantly, periodically or not periodically, including when operating time and the period of repetition vary by law of random numbers.

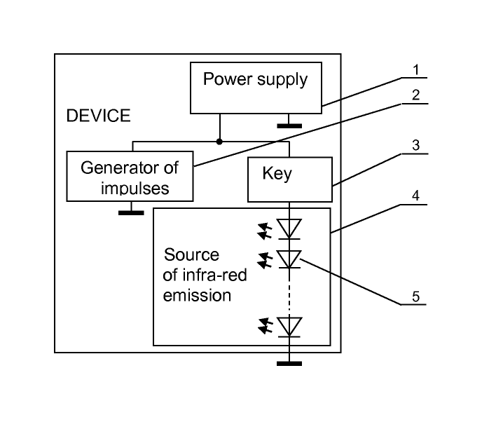

### FIELD OF THE INVENTION

The invention concerns area of protection of the person, agricultural cattle and pets from bites of blood-sucking insects (mosquitoes, mosquitoes, midges, etc. which are a carriers of a malaria and other infectious diseases) and can be used at home, in public places (schools, cinema halls, restaurants), and also in field conditions (at field works, in hikes, on hunting) and in production of cattle, rabbit and fowl.

### BACKGROUND OF THE INVENTION

Blood-sucking insects find the prey by finding his thermal emission from distances about 10 m. Last fact is widely used in known devices of protection of the person and animals from bites of blood-sucking insects. Into analogous devices there are special thermal elements which carry out function of lure. For this purpose, temperature of lure should be supported at level of body temperature of the person (of animals). Ordinarily, thermal lure is illuminator, for example, electric lamp, gas candle or electric heater, whose spectrum of emission contains the infra-red component. Such devices of protection are available on sale and, for example, are described in following patents:
U.S. Pat. No. 6,594,946 Nolen , et al. Jul. 22, 2003;
U.S. Pat. No. 6,860,061 Nosse , et al. Mar. 1, 2005;
U.S. Pat. No. 6,655,078 Winner, et al. Dec. 2, 2003.

The described method and devices with a thermal lures have many disadvantages which limits their efficiency and fields of usage, namely:
it is impossible to guarantee that insects will necessarily choose a lure, instead of people (of animals). People (animals) that are located near a lure may actually experience more mosquito bites than those that are located not near a lure, because those devices attracts more mosquitoes but don't kill them all;
if the thermal lures emits the visible light, it can disturb the people, creating undesirable illumination. Besides, the visible light emitted by the lure attracts the beneficial insects, results in unnecessary and unwanted killing of these insects helpful to agriculture and maintenance of ecological equilibrium;
devices with the thermal lures frequently are a very bulky devices that excludes they from such fields of using as hunt, fishing, camping, boating, walking excursion, war campaign etc;
level of risk of electric shock and fire risk can be big, because in devices use high-voltages and inflammable gas;
constructive complexity of such devices, does their too pricey. Due to their high retail price they are far out of reach of the ordinary consumer, especially, in several copies—when it is necessary, for effective protection of the house or office.

In the devices, which realizes other method of protection of the person (of animals) from bites of blood-sucking insects, the thermal elements are designed especially for a warming up and evaporation of repellents (of the substances influencing the behaviour of insects) or of insecticides. The devices known as trade marks “RAPTOR”, “FUMIGATOR” and “FUMITOX” are devices of such class. Such devices have many faults and restrictions too:
evaporated chemical substances may to cause adverse (dangerous) influence on the person (on the animals), for example, in the form of allergic reactions;
limited (no more than several months) effectiveness of active chemical substances (because, insects have ability to adapt for them). The World Health Organization in the newsletter No 94, May, 2007 noticed that insecticides are effective only to a limited amount of time. Moreover, many types blood-sucking insects are capable to develop resistance to the insecticides in a few generations (for mosquitoes it is only few months), and in the long run, this adaptation makes the species stronger;
delay of actuation of protection from the moment of the begin;
limited capacity of cartridges (containers) of the chemical substances, that lead to necessity of regular expenses for their manufacturing and their recycling;
necessity to repeat (times without number): switching on the device, switching-off the device, aerating of apartment after using of devices, etc. . . .

Prototype of the present invention is the method used in a military technology for a disorientation of means of air-defense. Method consists in generating of a powerful signal of hindrance (radio jamming) in frequency range of radar. Receivers of radar have the limited dynamic range of input signals. Powerful signal of a hindrance eliminates a possibility of radar station to discern weak useful signals of aircrafts, because receiver is overloaded by hindrance. Powerful hindrance camouflages weak useful signals, depriving radar of ability to define position of aircrafts in air space.

### BRIEF SUMMARY OF THE INVENTION

The purposes of the present invention:
an increase of efficiency of protection of the person and animals;
expansion of fields of using;
decrease of power consumption of devices;
reduction of constructive complexity, downsize and reduction of cost of devices;
an increase of operational reliability of devices;
reduction risk of electric shock, of fire risk and ecological danger of devices.

The present method is based on fact, that mosquitoes and other blood-sucking insects have principally infrared vision and actively attack people or animals at night, in twilight or in the shade, that is, in the conditions optimum for detecting infra-red emission of a body of the person and animals. The purposes of the present invention are achieves by creating in protected zones of a thermal hindrances, which deprive blood-sucking insects of ability to define position of people (of animals). The method consists in placing in zone of control of one or several sources of the infra-red emission, which have the wide diagram of emission. In comparison with of infra-red emission of a body of the person (animals) power output of infra-red sources must be considerably larger. Zone of protection should be blocked by thermal hindrances in the form of powerful direct beams and in the form of beams reflected from subjects. At certain level of power output of infra-red sources the thermal sensors of insects will be overloaded and will deprive blood-sucking insects of ability to define position of people (of animals).

Infra-red sources can operate constantly, periodically or not periodically. Periodical (or not periodical) actuation of infra-red sources reduces the power consumption. Continuous management of frequency and of duration of emission of infra-red sources excludes possibility of selection of algorithm of processing of signals which would allow insects to distinguish thermal radiation of people and animals.

The method may be realized with use of light-emitting diodes, which effectively transforms electric energy in emission of an infra-red range. Rapidity of light-emitting diodes provides fastness of actuation of protection. Additionally, rapidity of light-emitting diodes simplifies the realization of management of frequency and of duration of emission in the wide ranges. Light-emitting diodes and electronic controllers have big operational reliability, long average life, low price, small dimensions. They exclude fire risk and risk of electric shock.

### BRIEF DESCRIPTION OF DRAWING

Drawing represents one of the many eventual variants of realizations of the device which realize a method of protection.

### DETAILED DESCRIPTION OF THE INVENTION

Drawing represents one of the many eventual variants of electric schemes of the source of infra-red emission which realize a method of protection. The device comprises a power supply 1, a generator of impulses 2, an electronic key 3, and a source of infra-red emission 4, realized with use of light-emitting diodes 5.

The generator 2 generates rectangular impulses of voltage (electric current), whose width and the period of repetition can vary by law of random numbers (by other principle). In the elementary case, generator 2 generates impulses with constant width and with constant period of repetition. The electronic key 3 connects the light-emitting diodes 5 to the power supply 1—on a period of time equal to width of the impulses of generator. The light-emitting diodes 5 transforms the energy of the power supply into infra-red emission. That scheme allows to realize a miniature device of protection, suitable for the most different conditions and fields of using (for example, for embedding in elements of furniture and an interior of apartment, and even for attaching to elements of clothes, headdresses etc.).

1. A method of protection of human (livestock) from bites of blood-sucking insects consisting in placing in protected zone of (one or several) sources of infra red emission; power of emission must to exceed power output of infra-red emission of vulnerable parts of a body of the person (of animals); infra-red sources can operate constantly, periodically or not periodically, including when operating time and the period of repetition vary by law of random numbers; diagrams emission and a places of placing of infra-red sources must be organized so that this emission would to hit in eyes of insects (thermal sensors of insects) in the majority of possible points of supervision by them of people (of animals).
